(19) United States
(12) Patent Application Publication
(10) Pub. No.: US 2026/0064696 A1
(43) Pub. Date: Mar. 5, 2026

(54) In-Memory Semantic and Information Access Frameworks for Enterprise Data

(71) Applicant: Oracle International Corporation, Redwood Shores, CA (US)

(72) Inventors: Isaac William, Lantana, TX (US); Harshavardhan Takle, Foster City, CA (US); Kavin Kumar Kuppusamy, Fremont, CA (US); Venkata Srikanth Bavireddy, Tracy, CA (US); Sundar Narayanan, Belmont, CA (US)

(73) Assignee: Oracle International Corporation, Redwood Shores, CA (US)

(21) Appl. No.: 19/185,609

(22) Filed: Apr. 22, 2025

Related U.S. Application Data
(60) Provisional application No. 63/689,687, filed on Aug. 31, 2024.

(51) Int. Cl. G06F 16/2457; G06F 16/2455

(52) U.S. Cl. CPC G06F 16/24573; G06F 16/2455

(57) ABSTRACT

Techniques are described herein for implementing, deploying, and utilizing an in-memory information access framework for enterprise data using highly-resolved, semantically-complete, read-only data objects. Extraction workloads efficiently access enterprise data without incurring significant performance degradation to transaction entry workloads. Consumers access enterprise information in a user-intelligible fashion without any knowledge of the underlying data storage and relationship details of complex physical schema designs. Consumers access subsets of the read-only data objects by defining reusable and parametrized data slices. Consumers combine related data slices into data slice collections. Initially, the system receives a request for a dataset by specifying a data slice. The system accesses metadata for an object or view associated with the data slice to determine operations for accessing the requested dataset. The system generates a database query for retrieving the requested dataset. The system executes the database query on a database to retrieve and return the requested dataset.

### BENEFIT CLAIMS; RELATED APPLICATIONS; INCORPORATION BY REFERENCE

This application claims the benefit of U.S. Provisional Patent Application 63/689,687, filed Aug. 31, 2024, hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to in-memory semantic and information access frameworks for efficiently accessing enterprise data.

### BACKGROUND

Online transaction processing (OLTP) systems are designed to handle a large volume of concurrent, real-time transactions. The transaction data model of such systems is highly normalized to avoid data redundancy and optimized for transaction entry workloads, which include high volume CRUD (create, read, update, and delete) operations. For example, OLTP databases typically organize data into tables and relationships in a manner that minimizes duplication, enforce constraints such as foreign key constraints when data is written to the database to ensure consistency, and adhere to ACID (Atomicity, Consistency, Isolation, Durability) properties to provide reliable transaction processing. OLTP databases often organize table data in a row-oriented format to enhance the efficiency of operations of OLTP workloads that require accessing many columns of a single row.

The transaction data model that allows OLTP systems to be highly optimized for transaction entry workloads also leads these systems to be suboptimal for large-scale data extraction workloads. Reporting, extraction, and inquiry workloads often require resource-intensive table joins to present a functional view of the data. The performance of queries requiring table joins may be improved by indexing related columns between tables. However, predicting query patterns to determine which indexes to add in an OLTP database is often infeasible and may significantly slow down transaction processing. Another complication is that the implementers responsible for writing custom reports may not fully understand the transaction data model, potentially leading to inefficient queries that cause severe disruption to daily operations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example system architecture in accordance with some embodiments;

FIG. 2 illustrates an example logical layer schematic for a RODS database in accordance with some embodiments;

FIG. 3 illustrates an example data integration layer and data collection service of a logical layer for a RODS database in accordance with some embodiments;

FIG. 4 is an example set of operations for generating database queries using data slices in accordance with one or more embodiments;

FIG. 5A illustrates an example set of data slice definitions in accordance with some embodiments;

FIG. 5B illustrates an example set of consumption of data slices in accordance with some embodiments, and

FIG. 6 illustrates a computer system in accordance with some embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. INFORMATION ACCESS FRAMEWORK: READ-WRITE SEPARATION
3. INFORMATION ACCESS FRAMEWORK: SEPARATION BETWEEN LOGICAL AND PHYSICAL LAYERS WITHIN RODS
4. INFORMATION ACCESS FRAMEWORK: DATA INTERPRETATION LAYER AND DATA COLLECTION SERVICE
5. GENERATING DATABASE QUERIES USING DATA SLICE DEFINITIONS
6. MONITORING LIQUIDITY USING DATA SLICES
7. COMPUTER NETWORKS AND CLOUD NETWORKS
8. HARDWARE OVERVIEW
9. MISCELLANEOUS; EXTENSIONS

### 1. General Overview

Data consumption patterns have evolved over time with ever-increasing demands on enterprise systems. In particular, users increasingly expect enterprise systems to be able to handle online transaction processing (OLTP) workloads, consistent data streaming, and point-in-time extraction of massive amounts of data. For example, artificial intelligence (AI) and machine learning (ML) applications may benefit from consuming vast quantities of data, all or part of which may be stored in one or more OLTP databases. However, large-scale and frequent data extraction events may significantly degrade the performance of transaction entry workloads.

Techniques are described herein for implementing, deploying, and utilizing an in-memory information access framework for enterprise data using highly-resolved, semantically-complete, read-only data objects. The techniques allow extraction workloads to efficiently access enterprise data without incurring significant performance degradation to transaction processing workloads such as transaction entries. The techniques further allow consumers to access enterprise information in a user-intelligible fashion without any knowledge of the underlying data storage and relationship details of complex physical schema designs. Thus, the risk of inefficient queries negatively impacting transaction workloads may be mitigated.

In some embodiments, the framework includes a read-only operational data store (RODS) that is synchronized with an OLTP data store and provides information access to extraction workloads in a performant manner and without any data inconsistencies with the OLTP data store. Within the framework, the synchronized RODS does not support high-level write, i.e., CRUD, operations such as may be requested by an application user or an interface. Rather, the only changes to data in RODS is the synchronization process that is executed solely at the physical layer. Since high-level CRUD operations are not supported on RODS, the database does not consume resources to provide a read-consistent view which can be significant in high volume OLTP systems such as enterprise applications. RODS does not require a special database; the performance benefits are obtained by how the database is used as part of the framework. The system directs queries that require write operations to the OLTP data store with which the data is synchronized. As a result, the read-only data store may be optimized for varied, frequent, and/or voluminous read operations. Maintaining a parallel read-only infrastructure can also improve response times for transaction processing and user interface (UI) actions on the OLTP data store as extraction events are offloaded to a data store that is more optimized for handling reads. (As an example, voluminous or resource-intensive reads from OLTP databases cannot be timed during “down-times” particularly for global companies that use enterprise applications.)

In some embodiments, the framework provides separation between logical and physical layers within the read-only data store. For example, the read-only data store may be configured to deny direct physical access to the database to data consumers (end users and applications). The read-only data store may expose the physical database through a semantic layer, through which logical objects are managed to provide consumers with access to enterprise data in a more user-intelligible fashion. The semantic layer may shield consumers from the complexities of directly querying physical database objects (e.g., tables/views), avoiding the need to write complex joins and filters. The semantic layer may further present a single view of an object across all its constituent entities, allowing data consumers to query an object based on attributes spanning different entities in a highly performant and scalable manner. For example, a “General Ledger Journal” object may include attributes from various entities such as the Journal batch, Journal header, and Journal line levels or entities. A semantic data model may also provide a standardized object data shape for different applications to consume, which may help optimize high-volume data consumption applications such as training machine learning and artificial intelligence models.

One or more embodiments described in this Specification and/or recited in the claims may not be included in this General Overview section.

### 2. Information Access Framework: Read-Write Separation

Embodiments herein include a twin database architecture with a read-only operational store (RODS) that is synchronized with a read-write online transactional processing (OLTP) data store. The RODS database and the OLTP database may structure data differently at physical and/or logical layers to optimize for different workload types. For example, the RODS database may store data in column format rather than row format within memory. Column-oriented storage allows for more optimized reads for data extraction workloads by minimizing input/output operations. In particular, such workloads often request specific columns, and column-oriented storage avoids the overhead of having to read the entire rows. Column-oriented storage also allows for greater compression of data, as adjacent column values are more likely to repeat or be substantially similar than adjacent row values, which reduces the size of data that is read from disk. The OLTP database may store data in a row-oriented format to optimize for write operations as transaction entries typically target a single row. In other cases, a hybrid row and column-oriented format may be used for the RODS database and/or OLTP database. A hybrid format stores some of the data in columns and other data in rows to optimize for specific workloads. In such scenarios, generally the RODS database may have a higher level of column-oriented storage than the OL TP database (e.g., the percentage of tables, views, or portions thereof that are stored in column rather than row-oriented format is higher in the RODS database than the OLTP database).

Additionally, or alternatively, the RODS database may have other read optimizations applied independently from the OLTP database. Other examples include: (a) creating indexes on columns that are frequently used in query conditions (e.g., WHERE clauses) and joins during data extraction events, (b) caching data to store frequently accessed data in memory (c) partitioning tables to reduce the amount of data scanned during reads, and (d) adjusting database configuration settings (e.g., buffer pool size, cache size, read-ahead settings) to optimize read performance. Conversely, the OLTP database may have write optimizations applied independently from the RODS database.

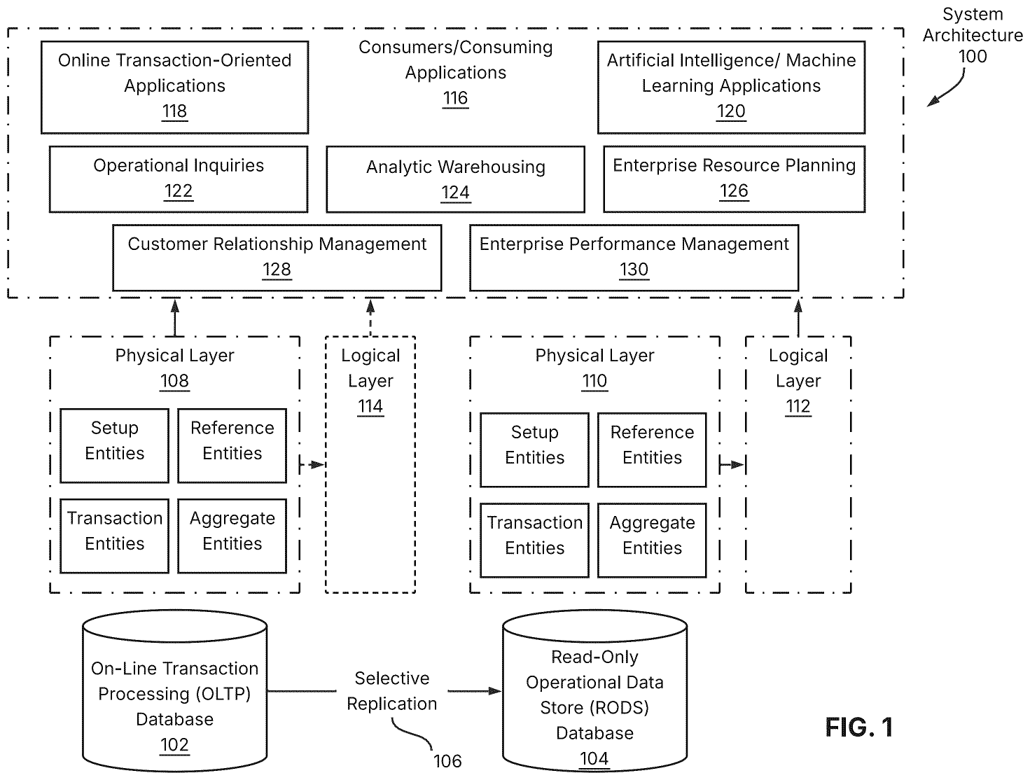

FIG. 1 illustrates an example system architecture in accordance with some embodiments. System architecture 100 includes an OLTP database 102 and a read-only operational data store database 104. OLTP database 102 is optimized for write operations, and RODS database 104 is optimized for read operations as previously discussed. In one or more embodiments, system architecture 100 may include more or fewer components than the components illustrated in FIG. 1. The components illustrated in FIG. 1 may be local to or remote from one another. The components illustrated in FIG. 1 may be implemented in software and/or hardware. Components may be distributed over multiple applications and/or machines. Multiple components may be combined into one application and/or machine. Operations described with respect to one component may instead be performed by another component.

Selective replication operation 106 synchronizes data between OLTP database 102 and RODS database 104. Selective replication operation 106 may synchronize all or a subset of data, depending on the implementation. For example, the system may replicate only data that is subject to access by read-only queries (i.e., enterprise data not accessed by the read-only queries is not replicated). Selectively synchronizing only a subset of the data reduces the amount of data that is replicated between the two databases, thereby reducing both processing and storage overhead. Database patching and upgrade events on OLTP database 102 do not interrupt information access for data stored within RODS database 104.

In some embodiments, selective replication operation 106 replicates data in near real-time to make a consistent set of data accessible for read-only operations. Oracle GoldenGate technology allows for such near real-time replication, although the replication technology used may vary depending on the implementation. The GoldenGate replication technology may include a capture (extract) process, trail files, a data pump, a delivery (replicate) process, and checkpointing. The Extract process runs on OLTP database 102. The extract process captures committed transactions from OLTP database logs, e.g., redo logs, and writes them to a trail file. Trail files act as a staging area for the captured data. These files store changes in a platform-independent format, allowing for flexible and efficient data transport. A secondary extract process, known as the data pump, can be used to read the trail files and send the data to RODS database 104. This helps in managing network latency and ensuring data integrity. The replicate process runs on RODS database 104. The replicate process reads the trail files, reconstructs the data manipulation language (DM L) and data definition language (DDL) operations, and applies the operations to RODS database 104. This process may use dynamic SQL to execute the operations efficiently. Both the extract and replicate processes maintain checkpoints to track their progress. This ensures that in the event of a failure, the processes can resume from the last known good state without data loss.

OLTP database 102 and RODS database 104 include physical layers 108 and 110, respectively. Physical layers 108 and 110 may include various entities, e.g., setup, reference, transaction, and aggregate. Setup entities support transactions and/or transaction processing. Setup entities typically include a low amount of data, and are usually static/rarely change, e.g., payment terms, currencies, various configurations and rules. Reference entities may include low to medium data volume that are less frequently changed. Reference entities may include a long life cycle and may be mainly used in or “referred” in other objects, e.g., transaction objects. Examples reference entities include project, asset, calendar, item, person, customer, and supplier. Transaction entities may include high volume and fast changing entities. Transaction entities may include a short life cycle (at least until the record or event becomes “historical”, such as an invoice that has been paid in full). Aggregate entities may include summarized, aggregated data for reporting. While also high volume and fast changing, aggregate entities/objects may include a coarser grain than the corresponding transaction entities/objects that the aggregate entities are aggregated from, e.g. account balances (aggregate) vs. journal entries (empty paragraph).

In some embodiments, physical layer 110 of RODS database 104 contains data selectively replicated in near-real time from physical layer 108 of OLTP database 102. The physical layout of the data may vary to optimize performance for the different types of workloads handled by each database. For example, as previously noted, OLTP database 102 may store the data in a predominantly row-oriented format, and RODS database 104 may store the replicated data in a predominantly column-oriented format (a hybrid format or purely columnar format may be used). The physical layout of RODS database 104 may thus be optimized for large joins and aggregations while OLTP database 102 may be optimized for transaction processing (e.g., row inserts, updates).

In some embodiments, RODS database 104 does not allow consumers 116 to directly access physical layer 110. All read-only accesses are made through logical layer 112, which exposes the enterprise data in an end-consumer-friendly format. Although logical layer 112 is depicted as a single layer, logical layer 112 may include multiple different layers to represent objects as discussed further below. Consumers 116 may directly access physical layer 108 of OLTP database 102 or OLTP database 102 may maintain a distinct logical layer 114, depending on the particular implementation.

In some embodiments, consumers 116, also referred to as consuming applications or consumer layer, include applications and/or other software processes that access and consume data from OLTP database 102 and/or RODS database 104. Consumers 116 include user-facing applications as well as backend processes and applications that lack a user-facing component. Consumers 116 may also include adapter or integration services for transmitting retrieved data to the consuming applications in a manner suitable for the particular consuming application.

In some embodiments, consumers 116 include one or more enterprise applications, such as online transaction-oriented applications 118, e.g., enterprise resource planning (ERP) 126, customer relationship management (CRM) 128, artificial intelligence (AI)/machine learning (M L) applications 120, operational inquiries 122, analytic warehouses (AW) 124, and enterprise performance management (EPM) 130. Online transaction-oriented applications 118 refer to applications designed to handle real-time business transactions on the internet. Examples of online transaction-oriented applications 118 include banking applications/systems, airline reservation/booking systems, online shopping applications/systems, and order entry applications/systems. A l/M L applications 120 refer to systems that are designed to perform tasks that typically require human intelligence and may require vast amounts of data. These tasks might include predictive analytics, natural language processing, and image recognition. Operational inquiries 122 refer to applications that query databases to retrieve information necessary for day-to-day operations. Examples of operational inquiries 122 include inventory checks, i.e., real-time queries to check stock levels, and customer data retrieval, i.e., accessing customer information for service or marketing purposes. Analytic warehousing 124 combines data warehousing with analytic capabilities. This involves aggregating historical data from various sources and running sophisticated queries to derive deep insights. Enterprise resource planning 126 refers to systems that integrate core business processes and functions across an organization. These systems manage finance, human resources, and supply chain operations. Customer relationship management 128 refer to systems used to manage a company's interactions with current and potential customers. This may include sales management, customer support, and/or marketing. Enterprise performance management 130 refers to software that helps organizations plan, budget, forecast, and report on business performance. Enterprise performance management 130 may also include strategic planning, financial management, and analysis.

In some embodiments, consumers 116 submit requests to the information access framework to access the underlying physical data. In response to an access request, the information access framework may determine whether to direct the access request to OLTP database 102 or RODS database 104, separating read-intensive operations from transactional activities. If the request is read-only, then the framework routes the request to RODS database 104. Otherwise, if a write is required, then the framework routes the request to OLTP database 102. Once the write is committed to the OLTP database 102, the change is replicated in near real-time to RODS database 104 (if part of the replication subset) to provide a consistent view of the data.

Data extraction, especially at volumes required for A I/ML applications, is a read intensive operation. As discussed above, OLTP databases are optimized for online transaction processing, not read intensive operations. Ensuring read consistency during an update on an OLTP database, i.e., high level write operations, e.g., insert or update, is a burden to the database. By performing read operations on RODS databases instead of on an OLTP database, the system is not unnecessarily burdened and is not slowed down.

### 3. Information Access Framework: Separation Between Logical and Physical Layers within Rods

As noted above, RODS database 104 provides separation between physical layer 110 and logical layer 112. The separation may help mitigate poorly written queries from negatively impacting performance. For example, inefficient join and filter operations may be prevented as RODS database 104 may only receive properly and accurately formed queries from logical layer 112. The separation of physical layer 110 and logical layer 112 also facilitates data consumption by providing access in a more user-intelligible fashion or in a format that is more optimized for downstream applications.

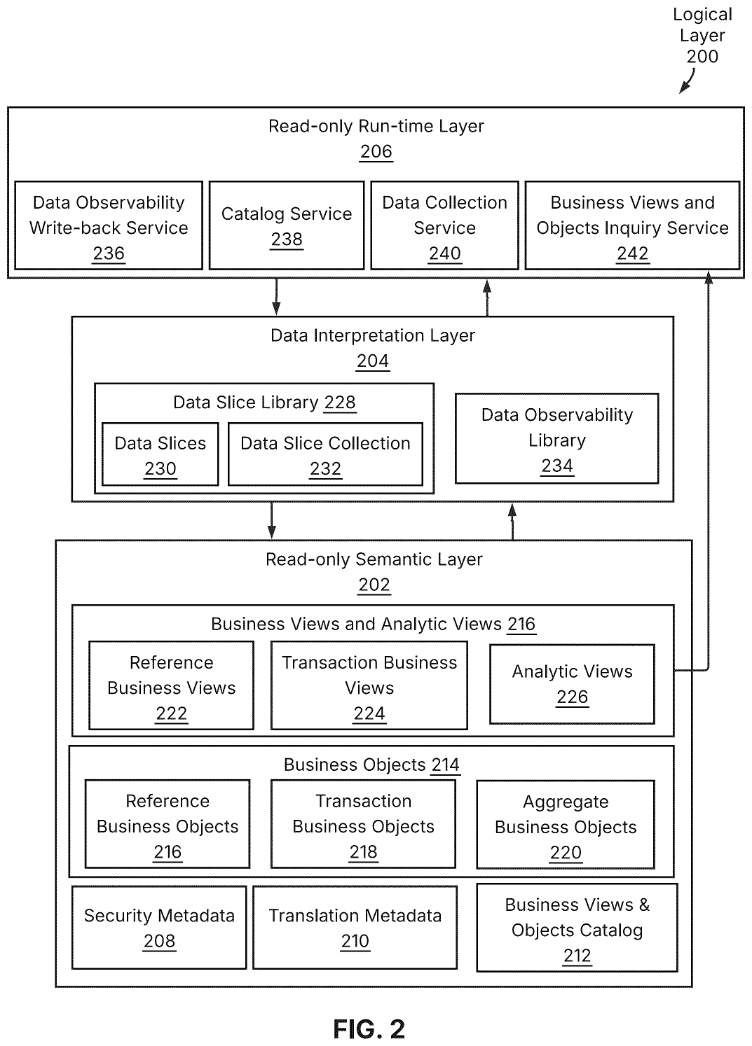

FIG. 2 illustrates an example information access framework schematic for the logical layer of a RODS database in accordance with some embodiments. Logical layer 200 of the RODS database includes three separate sub-layers, a read-only semantic layer 202, a data interpretation layer 204, and a read run-time layer 206.

In some embodiments, semantic layer 202 includes metadata designed to make interactions with the database more intuitive and meaningful from a business perspective. Metadata in semantic layer 202 may include security metadata 208, translation metadata 210, business views and object catalog 212, business objects (Bos) 214, and business views (BVs) and analytic views (Avs) 216. Security Metadata 208 refers to metadata that encapsulates who has read access to which BO, BV, or AV, and what data elements may be read in a specific data request. Translation metadata 210 defines rules and data for language translations. Metadata in this context defines the parameters, rules, and contextual information that guide how texts are translated from one language to another. Business views and objects catalog 212 contain an inventory of BVs and BO associated with the data in the RODS database.

In some embodiments, business objects 214 refer to a software abstraction of a real-world entity, and represents a person, place, thing, or concept from the business domain. Business objects 214 are metadata-only objects that hold definitions of the physical entities composing the BO, how those physical entities are related in order to produce the data for the BO, the business rules defining how the metadata object relates to other metadata objects, how the Bos are secured, how the Bos are to be accessed. A BO can comprise one or more physical entities, either directly or through other internal Bos.

In some embodiments, metadata representing Bos 214 may relate to organization of physical entities, business rules, and access rules. The organization of physical entities includes metadata that describes how physical data entities, i.e., database tables and columns, map to the BO. This may include transformations or translations needed to convert raw data into more meaningful business terms. Structural metadata defines the structure of a BO, including attributes, relationships with other Bos, and data types of each field. Business rules include validation rules and calculation logic. Validation rules specify conditions that data must meet to be considered valid within a context of a business. For example, a BO representing an order might have rules regarding minimum order amounts or required fields. Calculation logic includes formulas or expressions used to calculate values within the BO, e.g., total costs, tax calculations, or other derived business metrics. Access rules may include security metadata.

In some embodiments, business objects 214 include reference business objects 216, transaction business objects 218, and aggregate business objects 220. Reference business objects 216 include metadata used to store and manage static or slowly changing data that is used as a standard reference within the system. Transaction business objects 218 include metadata that may define attributes, relationships with other Bos, and business rules to handle transaction processing. Aggregate business objects 220 may contain metadata of the organization of physical entities, business rules, and access rules that are needed for analysis. The system may use aggregate business objects 220 for analysis and reporting purposes, providing summarized and computed views of data that help in decision-making processes.

In some embodiments, business views and analytic views 216 include reference business views 222, transaction business views 224, and analytic views 226. Business views 222 contain metadata designed to expose data of one or more related underlying Bos at a granularity of interest to an end user. Reference business views 222 provide standardized, consistent information that serves as reference across an organization. Reference business views 222 may relate to static data, lookup data, and validation. Transaction business views 224 focus on operational data that is generated through daily business transactions. The system may use transaction business views 224 for real-time monitoring, operational reporting, and status of processing. Transaction business views 224 may expose canonical dimensions, measures, and other dimensions as well as “denormalized” attributes of interest from related business objects.

In some embodiments, a business view has various categories of attributes-those that provide context, those that indicate the status, measure attributes such as amounts and quantities, category attributes that would use to slice or filter the data. Etc. Some attributes such as the Project Name or Purchase Order (PO) number will not be present in all rows. (In producing this view, such objects would be properly “outer-joined” to one or more reference objects so as to not result in disappearing rows.) In addition, certain attributes might be calculated or derived value representing, for example, the status that is derived from multiple objects. For example, a Payables Invoice Accounting Status is a value derived from inspecting all the distributions of the invoice.

In some embodiments, each business view includes a full complement of attributes to meet most business data requirements. Additionally, business views also include identifiers of related objects which may be used by a consuming application to join with and pull in other attributes. For example, the PO number would be included in the Supplier Invoice BV. If a consumer needs attributes such as PO Date, PO Type, etc., a Supplier Invoice BV may be joined with a Purchase Order BV. Additionally, different companies may use an industry-specific product classification such as Standard Industrial Classification (SIC) codes or United Nations Standard Products and Services Code (UNSPSC) or a government-mandated classification such as the Nomenclatura Comum do Mercosul (NCM) in Brazil or Harmonized System of Nomenclature (HSN) in India to classify products they buy or sell. In such cases, the consuming application can create a data request that joins Customer Invoice data with the classification scheme of their choice to produce a result set that makes sense to the business user.

In some embodiments, analytic views 226 contain metadata definitions of fact views and dimension views. A fact view may be built in memory during runtime to present (or produce) quantitative information for analysis in the context of one or more “dimensions” which lend context to the quantitative information. Each dimension has a corresponding dimension view that contains the set of related attributes that describe the facts. This is similar to fact tables and dimension tables in online analytical processing (OLAP) databases. However, where OLAP database persist fact tables and dimension tables in disk, analytic views 226 in read-only semantic layer 202 are metadata-only objects. Thus, the system may retrieve data from the underlying tables and aggregate at runtime rather than persistently store the data on disk as data cubes as is the case with OLAP databases.

In some embodiments, analytic views 226 provide aggregate query capabilities using multiple hierarchies—e.g., time and product hierarchies, geography/territory hierarchies and levels, etc. Since business users tend to work top down rather than bottom up, they would start with an aggregate representation and drill down to a level before they drill down into the details. Analytic views 226 makes this top down approach possible. In addition, analytic views 226 may provide an ability to define custom measure definitions—e.g., Sum of Accounted A mounts Same Period Prior Year—and allow users to use the custom measure definitions in their queries. Unlike in an OLAP database, these additional capabilities do not take any additional storage.

In some embodiments, analytic views 226, when coupled with the RODS database on an automated data warehouse (ADW) database (DB), e.g., Oracle Autonomous Data Warehouse, can leverage the simplicity and stability of SQL query constructs supported by Avs. For example, consider a sales Fact View consisting of Sales data organized by three hierarchical dimensions: (a) geography with hierarchy levels: Region>Country>State or Province; (b) Product: Category Level 1->Category Level 2>Product; or (c) Time: Year>Quarter>Month. This AV can be queried as shown below.
SELECT time_hier.member_name AS Time,
product_hier.member_name AS Product,
geography_hier.member_name AS Geography,
sales,
sales_year_ago,
sales_chg_year_ago,
sales_pctchg_year_ago
FROM
sales_av HIERARCHIES (time_hier,
product_hier, geography_hier)
WHERE time_hier.level_name in (‘YEAR’)
AND product_hier.level_name in
(‘CATEGORY_LEVEL_1’)
AND geography_hier.level_name in (‘REGION’)
ORDER BY time_hier.hier_order,
product_hier.hier_order,
geography_hier.hier_order;
   If aggregation by Country is required, all that needs to change is to replace REGION with COUNTRY. Nothing else changes. Behind the scenes, the ADW DB will transform this into a (much more complex) SQL query against the database. The metadata that the Aggregate View layer needs to store in order to generate the SQL statement is thus vastly simplified while providing the ability to support extremely complex hierarchical and dimensional queries.

In some embodiments, analytic views 226 also support multiple hierarchies for the same underlying object reference. For example, the same product reference may be classified under multiple classification schemes (or hierarchies). Multiple classification schemes may include a product that is, for example, classified under different catalogs based on its taxability in the EU, in Austria (AT), in Germany (DE).

In some embodiments, read-only semantic layer 202 includes a catalog containing an inventory of BVs and Bos. The inventory may provide a list of existing BVs and Bos, which may be used to locate the corresponding metadata and rules to process data requests.

In some embodiments, data interpretation layer 204 includes a data slice library 228 comprised of one or more data slices 230. A data slice in this context refers to a well-defined, parameterized and reusable subset of data. Data slices 230 represent easy-to-consume data components that can be used individually or combined with other data slices for a functional purpose. Stated another way, a data slice may be defined for one use and be reusable for multiple purposes by different consumers. The same data slice can also be requested at different times with different parameters, thus allowing different data to be returned at different points of time with one single definition. In some embodiments, data slices are predefined or “seeded” by a provider. In some embodiments, users may be allowed to modify predefined data slices or define new data slices.

In some embodiments, a data slice definition defines the associated data slice name, data source, filter criteria, dimensions, and measures. The data slice name is an identifier for a unique functional unit of data, e.g., Supplier Payments, Receivables Due, Unapplied Receipts. The data source represents, for example, an underlying ERP data set for the data slice. A data slice may use a BV or AV as the source. A data slice may use as its source a BV that includes information that was written back to the OLTP database through the action of system bots in some implementations. Example data sources include Receivables Balance, Bank Balance, Payables Payment Summary, General Ledger Journal Summary. The filter criteria, also referred to as filter conditions, represent functional criteria for filtering a data source, e.g., Invoice Status=‘Unpaid’, Journal Source=‘Payroll’. The dimensions are attributes of a data slice that can be used for multi-dimensional analysis of the source data from an AV or a BV. Dimensions maybe used as part of filter conditions, parameters, and grouping criteria. As mentioned above a dimension may be created from data that was propagated into the OL TP database through the action of system bots. The measures represent a numerical attribute of the data slice, for example, a quantitative, i.e., monetary value or a count, e.g., Accounted Amount, Entered Amount, Receipt Amount

In some embodiments, data slices 230 are associated with dimensions that are periodically evaluated or refreshed based on measures such as top-n criteria. Such dimensions represent numerical attributes of underlying data and allow the data requester to analyze the data, for example, based on dynamic tiering. For instance, bucketing sales into top 10 customers may vary from month to month.

In some embodiments, data slices 230 allow for more meaningful operational queries, enhanced data interactivity in Uis, and efficient data accesses in low code (or no code) platforms.

In some embodiments, data slice library 228 includes a data slice collection 232 that enumerates a set of data slices commonly requested together, or make sense together. For example, a “Current Assets and Liability” collection that includes Accounts Receivables, Cash Account and Accounts Payables balances.

Data slice collection 232 represents a collection of data slices for consumption as one unit of extraction. The framework may track statistics on how often different slices are concurrently accessed by the same request, and data slice collection 232 may include groupings that occur according to a threshold frequency or number of requests.

In some embodiments, data slice library 228 includes a definition of consumers using a collection or individual data slices. The definition may be used to optimize reads based on the consumer or the type of consumer or the type of consumption that is requesting the data.

In some embodiments, data slice library 228 includes a data observability library 234. Data observability library 234 refers to a collection of tools, frameworks, and methodologies designed to help organizations monitor, manage, and understand data within data ecosystems.

In some embodiments, read-only run-time layer 206 includes data observability write-back service 236. Data observability write-back service 236 may include monitoring tools, an automation engine, a data validation layer, an user interface (UI), APIs/Integration points, and a security module.

In some embodiments, read-only run-time layer 206 includes a catalog service 238. Catalog service 238 may provide a listing of available reference BVs 222, transaction BVs 224, Avs 226, and data slices 230.

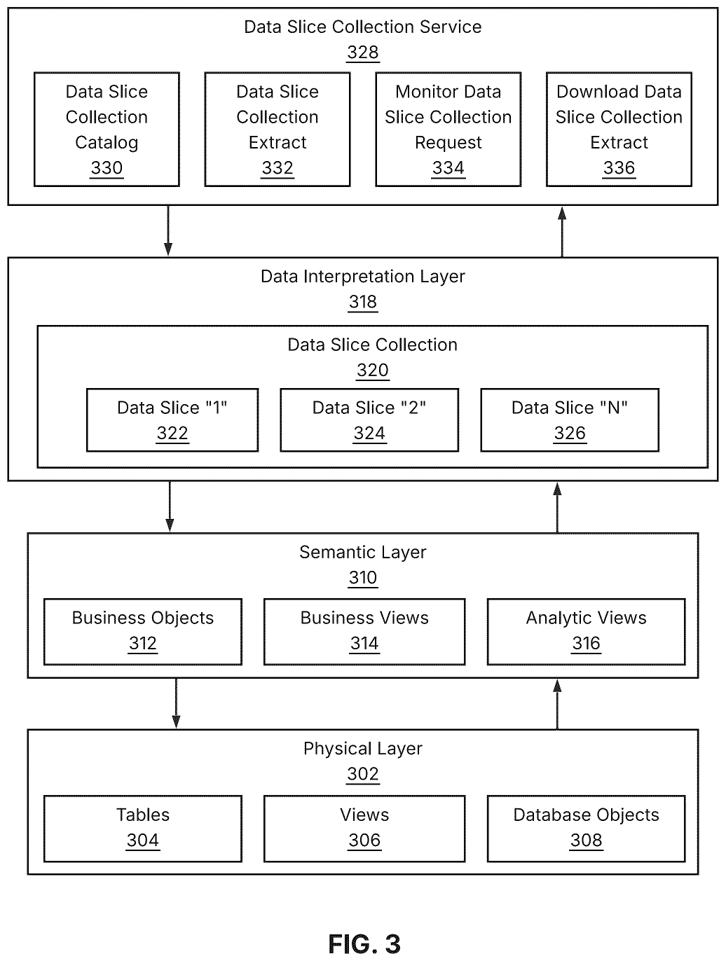

In some embodiments, read-only run-time layer 206 includes data slice and collection service 240. Data slice and collection service 240 fulfills requests for a specific data slice or data slice collection by interacting with various components including source definitions, catalog service 238, and read-only semantic layer 202 to provide a subset of data for the requested data slice or the data slices that comprise the data slice collection requested. Data slice and collection service 240 is described in further detail below with respect to FIG. 3.

In some embodiments, read-only run-time layer 206 further includes a business view and object inquiry service 242. Business view and object inquiry service 242 may field data requests from consumers and may validate the data requests. Business view and object inquiry service 242 may transform validated data requests into queries against the RODS database using the metadata within data slice library 228 and business views and objects catalog 212 in read-only semantic layer 202. Business view and object inquiry service 242 may return the results to the consumer. The views and objects inquiry service may use security metadata in the semantic layer to only request from the RODS database the data and data elements that the consumer is allowed to read. Additionally or alternatively, business view and object inquiry service 242 may use a database provider-specific adapter to translate the data request into queries against the physical layer of the RODS database.

In some embodiments, when business views and objects inquiry service 242 receives a request to query a BV, business views and objects inquiry service 242 accepts as its payload a list of attributes that the data requester needs. Depending on the attributes requested, a query generator will only include the business objects that need to be joined to produce the output requested, or, in other words, to service the request. In effect, it is as if it is a hand-coded SQL for the specific data request. In addition, business views and objects inquiry service 242 ensures that the data requested only returns rows attributes that the requester is granted the privileges to read. Further, using the business object metadata, a query generator will always supply the right join conditions, etc., that the data model design requires, and will apply these conditions consistently across data requests unlike a hand-coded SQL. Since the generated SQL queries would be identical for semantically identical requests across consumers, a database optimizer can use this to speed up query processing since the database optimizer has “seen” such a query before. (This is unlike specifically coded SQLs that may be semantically identical but not quite identical from the point of view of the query parser in the database.) When business views and objects inquiry service 242 receives a request to query data from multiple BVs, i.e., joins and or unions of multiple BVs, business views and objects inquiry service 242 may use the metadata, as explained above, to produce a consistent and accurate SQL query.

In embodiments, when business views and objects inquiry service 242 receives a request to query an AV, business views and objects inquiry service 242 accepts as its payload a list of attributes that the data requester needs. Depending on the attributes requested, the kind of aggregation (sum, average, etc.) as well as other more complex measures requested, a query generator may generate a SQL query needed to fulfill the data request. If RODS database uses a database such as Oracle's ADW, the metadata needed by an aggregate view component is much less complex, and the query generator can handle extremely complex data requests quite simply, quickly, and efficiently.

### 4. Information Access Framework: Data Interpretation Layer and Data Collection Service

Even with business views and analytic views, obtaining a meaningful (or functionally significant) subset of data remains difficult. “Overdue customer invoices” or “outstanding supplier balances” are examples of obtaining a meaningful subsets of data. To request overdue customer invoices for U.S. legal entities, a consumer would need to identify the appropriate AV—e.g., Receivables Invoices AV- or BV and specify conditions such as “Balance>0”, “Due date<system date”, “Legal Entity Country=“U.S.” The next time a user might need similar data but for UK legal entities. The same process used for the US legal entities would need to be repeated for the UK legal entities. By allowing a definition of predefined data slices, the collection of data slices can be reused by multiple users. In addition, a data slice definition may support parameterization such that a single data slice definition can serve multiple use cases. For the example given above, a data slice could be defined on the Receivables Invoices AV as the source with the filter conditions as “Balance>0” and “Due date<system date”, etc. The data slice could also allow for parameters such as “Legal Entity Name”, “Legal Entity Country”, “Customer Country”, “Invoice due date”, etc., that a business user will conceivably need for analysis. Thus, with a single data slice definition of the “Overdue Customer Invoice” data slice, different users can request different subsets of data at different times by specifying values for parameters as required by them.

In an example, a Cash manager is interested in the net cash position as of today or a future date. Cash position includes expected cash balances, cash inflows and cash outflows. Cash inflows expected would include open customer invoice balances, expected invoices from orders and subscriptions. By the definition above, each item for cash inflows is a data slice. Thus, cash inflows are comprised of multiple data slices. Expanding this further, the cash position is made up of multiple data slices of one or more types or categories. These are used as a whole with common dimensions, such as legal entity, date, party, etc. Such collection of data slices is referred to as a data slice collection. Data slices may come from different sources. For example, when determining an ERP Cash Position, sources may include Accounts Payable (AP), Accounts Receivable (AR), Cash Equivalents (CE) and General Ledger (GL), while external systems, e.g., external payable system or a purchase order system, may feed to the ERP GL via direct GL Feeds. User configured data slices from the GL may include, for example, Salary Payments: Payroll and/or Purchase Accrual: Receipt Accounting.

Each data slice collection is comprised of multiple data slices. Each data slice has a source of data and what condition should be met in order to form the data slice. The source of the data slice may include a business view, or an external source, e.g., GL. Each data slice may include one or more dimensions.

FIG. 3 illustrates a representation of data slices and data collection service. A physical layer 302 may include tables 304, views 306, and DB objects 308, e.g., indexes. On top of physical layer 302 is a semantic layer 310. Semantic layer 310 may contain business objects 312, business views 314, and analytic views 316. Semantic layer 310 may provide a layer of abstraction on top of physical layer 302. On top of semantic layer 310 is a data interpretation layer 318. Data interpretation layer 318 may include multiple data slice collections, e.g., data slice collection 320. Data slice collection 320 includes data slices “1” 322, data slice “2” 324, and data slice “N” 326. Each data slice 322, 324, 326 relates to a business object, business view, or analytic view in semantic layer 310. As described above, in addition to a source, each data slice 322, 324, 326 may include filter criteria, dimensions, and measures. Data interpretation layer 318 provides another layer of abstraction on top of semantic layer 310.

In an example, a business view can be defined with a table as the source of its data, however, the user may only be interested in a slice of data coming out of that table, not the complete data. Traditionally, to access that slice of data from the underlying shape, the user would need to understand the business object layer of the particular shape and write filter conditions and select a subset of attributes of columns from that shape. Instead, the system may provide a data slice out-of-the-box that includes the filter conditions and the subset of attributes stored as metadata. Using the metadata for the particular data slice, the system can produce or make available this slice of data without the user needing to understand the underlying filter conditions or subset of attributes.

In some embodiments, a data request for a data slice includes a data slice name and parameters that the user is interested in. For example, parameters may include a particular legal entity or a date range for due dates.

In some embodiments, the system provides data slice collection service 328 for accessing and handling data slice collections. Data slice collection service 328 may include a data slice collection catalog 330, a data slice collection extract 332, a monitor data slice collection request 334, and download data slice collection extract 336.

In some embodiments, data slice collection catalog 330 refers to software that performs operations described herein for providing a list of data slices available to a consumer. Data slice collection catalog 330 may provide the list of data slices in a graphical user interface (GUI).

In some embodiments, data slice collection extract 332 refers to software that performs operations described herein for extracting data for a data slice or a data slice collection. More particularly, data slice collection extract 332 uses the definitions of the data slices that make up the data slice collection to access metadata from the necessary BVs and/or Avs in the semantic layer. The metadata provides data slice collection extract 332 with the operations for performing a data extract. Data slice collection extract 332 may generate a database query using the metadata and may execute the database query on a RODS database. Data slice collection extract 332 may return the data for database query. Data slice collection extract 332 may collate the data before publishing the data. The system may save the data for the data slices of the data slice collection in a file available for download. The process of extracting the data for the data slices of the data slice collection is asynchronous.

In some embodiments, monitor data slice collection request 334 refers to software that performs operations described herein for monitoring the data extraction process. Download data slice collection 336 performs operations for downloading the file that includes the data for the data slices of the data slice collection.

### 5. Generating Database Queries Using Data Slice Definitions

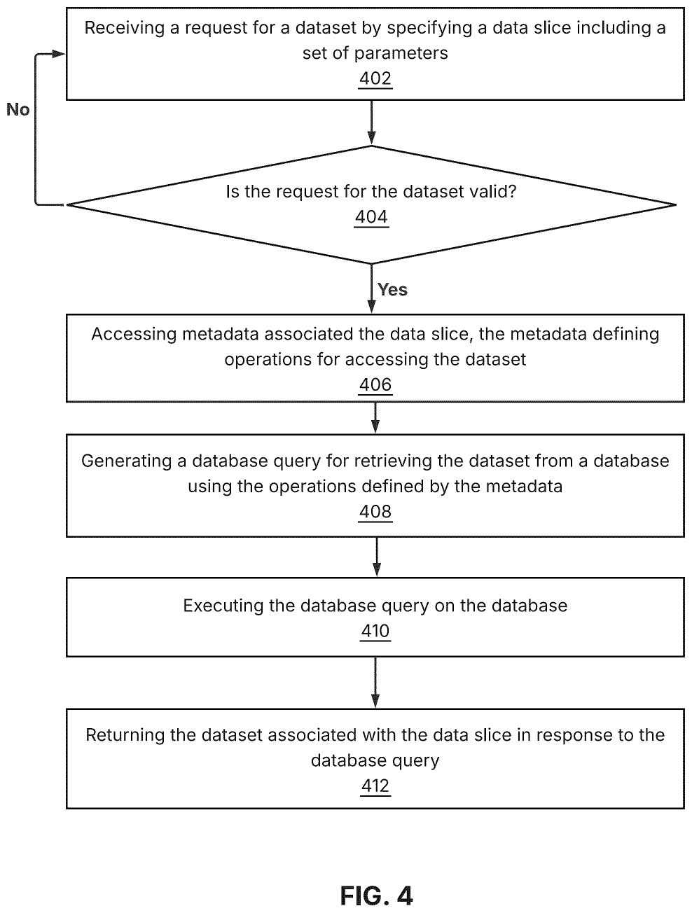

FIG. 4 illustrates a sample set of operations for generating database queries with data slices in accordance with one or more embodiments. One or more operations illustrated in FIG. 1 may be modified, rearranged, or omitted all together. Accordingly, the particular sequence of operations illustrated in FIG. 4 should not be construed as limiting the scope of one or more embodiments.

One or more embodiments receive a request for a dataset by specifying a data slice including a set of parameters (Operation 402). A data request for a data slice includes a data slice name and a set of parameters of interest associated with the data slice. Alternatively, the request for the dataset may include requesting a business view, analytic view or business object along with a set of parameters. The system may make the data request as query to a sematic layer. A user may select a data slice displayed in a graphical user interface (GUI). The GUI may present optional parameters for the data slice. Selection of parameters may include selection of an entity, such as a company, an organization structure used by the company, and/or other terms used to distinguish the company, e.g., geographic location. The user may request the data slice by selecting displayed elements with a cursor, by entering text in a text entry field, by dragging and dropping displayed elements, or using other forms of input.

Additionally, or alternatively, an application may generate the data slice request while performing operations, without presenting a user-facing interface. For example, an application may regularly retrain a machine learning model using a dataset of documents. The application may regularly request a database for the dataset of documents. The application initiates the query by generating a data request that specifies one or more data slices. The system translates the data requests into a database query to a set of objects stored in a database. The database query specifies the names of database tables and database table attributes. In some examples, a user may select an interface element in the GUI to initiate a query. For example, an application for viewing financial documents may include selectable buttons, including “in the last year,” “generated by User A,” and “Invoices for Company A.” A user may select a button associated with a data slice and parameters, e.g., filter conditions, to filter data represented by the data slice to cause the application to generate the data request.

According to an example embodiment, the system is configured to not recognize and/or authorize data requests that include database table names and/or database table attribute names. Instead, the system allows a user or application to access data in a database by generating a data request specifying a data slice or a data slice collection that is/are mapped to BVs and Avs associated with data in the database. In one embodiment, a user accesses data in a database by interacting with a GUI. The system presents in a GUI data slices or data slice collections. The system does not present in the GUI database table names and/or database table attribute names.

One or more embodiments determine that the request is valid (Operation 404). To determine that data request is valid, the system may authenticate the identity of the user or application making the request and may determine if the authenticated user has permission to access the requested data. Verifying an identity of the user or application may involve checking tokens, usernames, passwords, or other authentication methods. Determining if the authenticated user has permission to access the requested data may involve checking roles, permissions, and policies associated with the user's profile or application. The system may also validate the parameters of the request to ensure the parameters conform to expected formats and values. Validating parameters may include checking data types of the parameters, e.g., ensuring a date is passed where a date is expected. Validating parameters may include ensuring that parameters fall within allowed ranges or match allowed values. Validating parameters may include ensuring that the request conforms to the expected syntax.

One or more embodiments access metadata associated with the data slice, the metadata defining operations for accessing the dataset (Operation 406). For example, a data slice may be associated with a business object, e.g., “Payables Invoice”. This business object may include a set of three tables joined by two join operations. A user selection of an interface element in a GUI representing a data slice associated with the business object “Payables Invoice” causes the system to identify the set of three tables and two join operations specified in the metadata. The system may further identify that the data associated with the data slice and the parameters specified only require two of the three tables associated with the business object, and only a single join operation is necessary to return the data associated with the request.

One or more embodiments generating a database query for retrieving the dataset from a database using the operations defined by the metadata (Operation 408). Generating the database query includes generating a logical plan from the identified join operations in the metadata. Generating the database query further includes generating or selecting a physical execution plan based on the logical plan. As described herein, a logical plan specifies a set of tables and a set of join operations to join the tables associated with a particular query or set of queries. In one embodiment, the system filters the tables and join operations specified in metadata to generate a logical plan. The logical plan specifies a subset of the tables and filters specified in the metadata. The subset includes the tables and join operations needed to access data requested in request. The subset excludes tables and join operations that are not needed to access data requested in the request. According to one embodiment, a logical plan may be represented as a join tree. The apex of the join tree is a child table that uniquely joins to one or more parent tables. The parent tables may uniquely join to one or more additional tables. In an embodiment, in the logical plan, the order in which the parent tables are listed is irrelevant since logical plans as defined herein do not specify an order for performing join operations.

In one or more embodiments, generating the database query includes generating or selecting a physical query execution plan. Physical query execution plans identify how a logical plan will be executed on physical data structures. The physical plans specify operations, algorithms, and access methods that are implemented on the actual data stored in a database. The physical plans specify physical stored structures, including particular indexes, tables (including particular columns and partitions in the tables), and hardware resources. For example, a logical plan may specify a join operation to join two tables. The tables may include a different number of partitions located on different nodes of a database cluster. The logical plan identifies the tables and the join operation. The logical plan may not identify the different partitions. The logical plan may not specify an order for accessing data in the different partitions. The physical plan identifies how the join operation will be executed across multiple partitions stored in different physical memory locations.

According to one or more embodiments, a query optimizer generates a set of strategies to reach a set of tables and execute join operations based on the logical plan. The query optimizer calculates the cost for a strategy. For example, the query optimizer may calculate an estimated execution time and processing resources required to execute the strategy. Accessing data from different partitions of a table in different orders may result in different query costs. The query optimizer compares the estimated costs for the strategies to a cost model. Based on the comparison, the query optimizer selects a particular query execution strategy as a physical plan to implement the join operation.

One or more embodiments execute the database query on the database (Operation 410). The system may execute the database query with a query executor. The query executor applies a selected physical execution plan to identify and carry out the particular operations on particular data objects. The query executor interacts with a data storage engine to access the data objects stored in a RODS database. The query executor executes table scans, index lookups, joins, and other operations. The query executor applies filtering conditions and processing aggregations. The query executor manages concurrent processes and transactional aspects of the data access, modification, and retrieval.

One or more embodiments return the set of data associated with the data slice in response to the database query (Operation 412). For example, the system may return a set of records to a user or application in response to the data request. According to another example, a user interacts with a view representing a set of metadata attributes in a GUI to initiate a data request. The system translates the data request into the database query, as discussed above. The system presents in the GUI a set of values requested in the data request. The system presents the values as values for the metadata. In other words, after executing the query to the physical tables, the system re-translates the physical table attributes into the corresponding metadata object attributes for presentation to the user.

For example, a user may interact with a GUI to request a set of records for a data slice called “Customer Invoices.” The system translates the data request into a database query to a set of tables including “Customer_Accounts,” “Customer_Invoices,” and “Customers”. The database query returns a set of records. Instead of presenting the records with their corresponding database table names and database table attribute names, the system presents the records with their corresponding metadata object names and metadata object attribute names. For example, the database table Customer_Invoices may have attributes called “Total_Invoice_Amount_Due” and “Total_Invoice_Amount_Paid.” The system may present the value stored in these attributes as a metadata attribute name “Remaining balance:” by subtracting the value in “Total_Invoice_Amount_Paid” from the value in “Total_Invoice_Amount_Due”. Accordingly, the system presents data in a format that is understandable and ingestible by a data consumer while providing the data consumer with access to data stored in a database.

According to one or more embodiments, a system improves performance of database queries to database tables by using a data interpretation layer and a semantic layer between a data consumer layer and a database layer. The data interpretation layer and a semantic layer provide an initial improvement to execution of queries by logically grouping sets of queries into metadata objects. When a system receives a data slice request, the system determines which tables and join operations are specified in metadata objects to generate an initial set of candidate tables and candidate join operations for execution of the database query. A developer or user does not need to know database table names and database table attribute names to access data stored in database tables. According to another example, the logical grouping of tables may be based on authorization requirements. For example, Tables A and B may be accessed by an application with one authorization level. Tables C and D may be accessed by any application with another authorization level. The system may specify tables A and B in one metadata object and tables C and D in another metadata object.

According to one or more embodiments, the system further improves performance of the database queries to the database tables by handling data requests associated with read-only type requests differently than read/write data requests. The system may route read-only type data requests through a logical layer including a data integration layer and a semantic layer. The system may bypass the logical layer to execute requests to modify database data. For example, the system may route data requests to view historical records (e.g., invoices, transaction records, reports) through a logical layer to access the requested data from a database. The system may bypass the logical layer for requests to generate new invoices, record a new transaction, or modify an existing report.

In one or more embodiments, the system determines whether or not to route the data request through the logical layer based on an application programming interface (API) endpoint included in the data request. A data request to retrieve data without modifying the data may include an API endpoint. A request to modify data stored in a database may include a different API endpoint. According to another example, the system analyzes request information to assign an API endpoint to the data request. For example, the system may determine that one set of applications is restricted to accessing data without modifying the data. The system may assign the API endpoint associated with the metadata object management platform to requests from this set of applications. The system may determine that another set of applications is authorized to modify database data. The system may assign the API endpoint associated with the database modification platform to requests from this set of applications.

In one or more embodiments, the system further improves performance of the SQL queries by maintaining one database that may be accessed by read/write type requests and a RODS database that may be accessed by read-only type data requests. In particular, the system may direct SQL queries originating from a consumer application to the read-only database. The consumer application may not be authorized to modify the RODS database. The system may direct SQL statements from other specified applications to a read/write database. The system may periodically update the read-only database based on changes to the read/write database. In other words, the system may prevent applications accessing the read-only database from modifying the read-only database. Instead, the modifications to the read-only database are made based on modifications to the read-write database. In one embodiment, the modifications to the read-write database are automatically kept synchronized to the read-only database by using a database synchronization mechanism, e.g., GoldenGate.

In one or more embodiments, an API for the system does not expose database table data, such as database table names and database table attributes (e.g., column names). Instead, applications requesting data from the database tables are prevented from requesting the data directly from the database tables. For example, a request for a set of objects that may be accessed by an application may include a set of metadata objects and may exclude the database tables. In one or more embodiments, an API for the system may expose the database tables. In an embodiment where the system maintains a read/write database and a read-only database, the API for the system may expose the tables in the read/write database without exposing the tables in the read-only database.

One or more embodiments generate metadata objects mapping metadata object attributes to database table attributes. A metadata object includes at least an object name and at least one attribute name. The metadata object includes a mapping of the attribute name to a database table attribute name. For example, a database table attribute name Emp_Cd may be mapped in the metadata object to a metadata object attribute name “Employee Number.” One metadata object may be mapped to multiple database tables. When one metadata object is mapped to multiple database tables, the metadata object includes join operation data specifying join operations required to join multiple tables. One metadata object may be mapped to a subset of columns in a database table. Another metadata object may be mapped to other columns in the same database table. In one or more embodiments, generating a metadata object does not generate a new table in a database. Likewise, modifying a metadata object may not modify data in a database. For example, changing a metadata object attribute name “Employee Number” to “Employee Code” does not change the database table column name “Emp_Cd” mapped to the metadata object attribute name. Accordingly, the system provides an additional improvement in a database environment of allowing for generation, modification, and organization of metadata objects that access underlying database tables without modifying attributes or contents of the underlying database tables.

### 6. Monitoring Liquidity Using Data Slices

A detailed example is described below for purposes of clarity. Components and/or operations described below should be understood as one specific example that may not be applicable to certain embodiments. Accordingly, components and/or operations described below should not be construed as limiting the scope of any of the claims.

In an example, a treasury manager or chief financial officer may need to monitor liquidity. Data slices are defined and used for monitoring liquidity. The system may monitor liquidity using Current Ratio, Quick Ratio, Inventory Turnover, and Debtor Turnover.

Current ratio, a measure of short-term liquidity, is defined as the ratio of Current Assets to Current Liabilities. A Current Ratio of more than one indicates that the entity is able to pay its Current Liabilities using its Current Assets. The data required to compute the current ratio includes Current Assets balance as of the required date in a specific currency—e.g., Ledger Currency, and Current Liabilities balance as of the required date in the same currency.

Quick Ratio is defined as the ratio of “Quick Assets” to Current Liabilities. “Quick Assets” are Current Assets less the Inventory balance as on the required date. A high Current Ratio but low Quick Ratio will indicate that a lot of current assets are tied up in inventories. To compute the quick ratio requires the two balances needed for the Current Ratio, plus the balance of Inventory. Additional data required to compute the Current Ratio includes Inventory balance as of the required date (in the same currency as Current Liabilities).

Inventory Turnover Ratio is the ratio of Cost of Goods Sold over the Average Inventory and is used to indicate how efficiently a company uses its assets to generate sales. In addition to the balances needed for the Quick Ratio, a total Cost of Goods Sold from the beginning of the year till the required date is needed. Data required to compute the Current Ratio includes (a) Inventory balance as of the start date (e.g., beginning of the year); (b) Inventory balance as of the required date; and (c) Cost of Goods Sold from the beginning of the year till the required date. While the Inventory Turnover indicates how fast a company sells its products, the Receivables Turnover Ratio indicates how quickly the company collects on the sales it makes.

Receivables Turnover Ratio is defined as the ratio of (Credit) Sales over Average receivables for the given period. Assuming that predominantly all Sales are credit sales, the data requirements, i.e., data slice, includes (i) Sum of Revenue from the beginning of the year till the required date in a specific currency; (ii) receivables balance as of the start date (e.g., beginning of the year) in the same currency; and (iii) Receivables balance as of the required date) in the same currency.

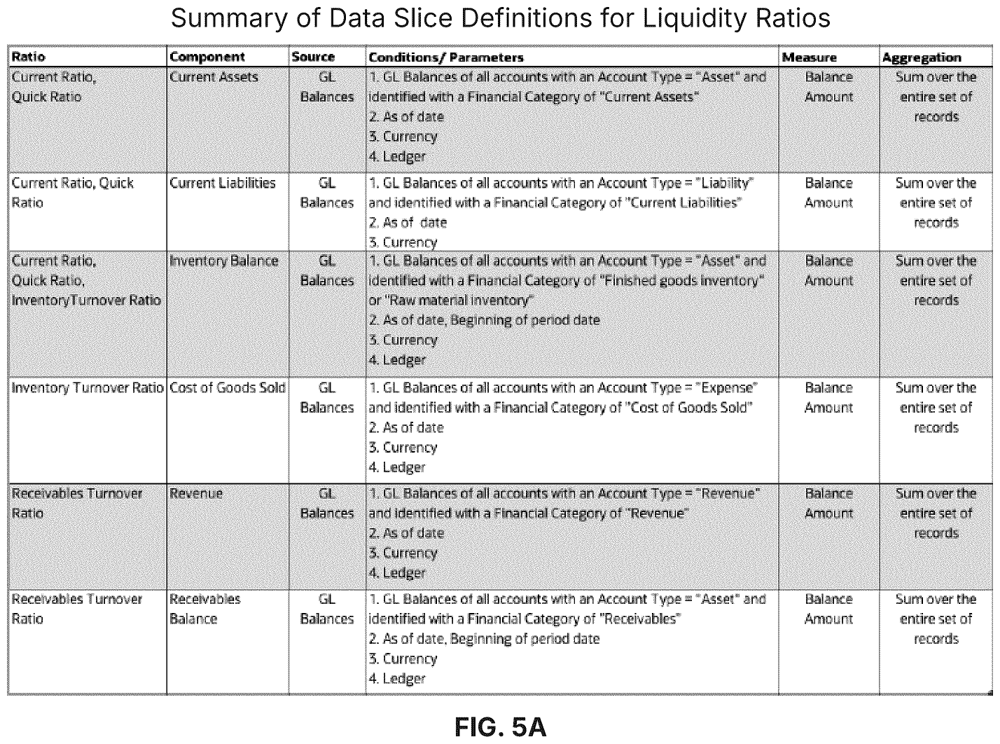

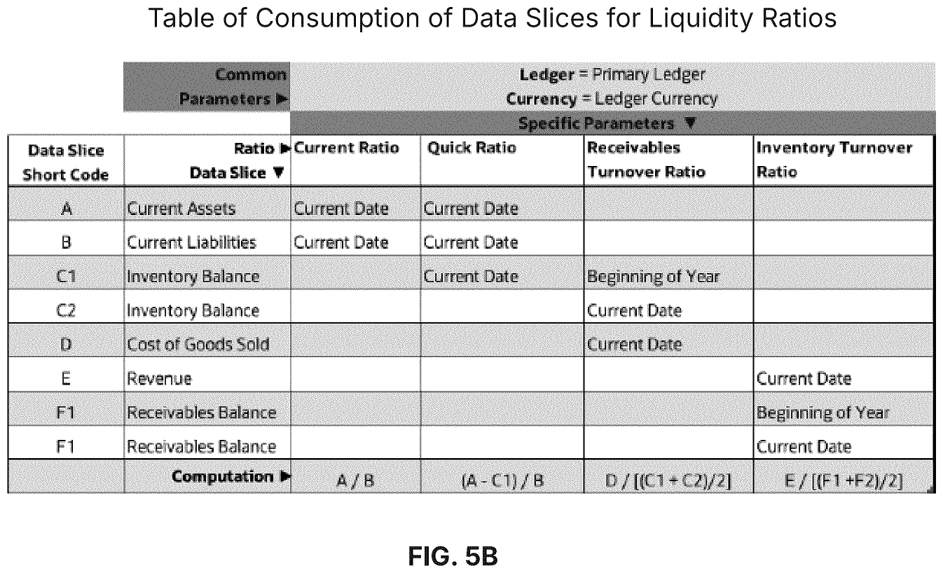

FIG. 5A is a table summarizing the data requirements needed to compute various liquidity ratios. As shown in the table, in some cases the same data is required to arrive at multiple liquidity ratios. For each component of a ratio, the data requirement can be abstracted into the following parts: source, sub-setting or “filtering” conditions, parameters, measures, and how each of the measures are to be aggregated. Sub-setting or “filtering” conditions narrow down a dataset to the set of records of interest. Parameters may need to be specified by the consumer each time the data is requested. In some embodiments, mandatory parameters accompany measures. For example, an amount needs a currency to be specified. A quantity needs the Unit of Measure to be specified. Measures may include amounts or quantities. Each component, or more precisely, the data requirement for each component comprises a data slice.

FIG. 5B is a table that summarizes how a consumer would use the data slice definitions needed to compute various liquidity ratios. For each of the data slices, the table shows the parameters that are specified by the consumer. For simplicity, the Ledger and Currency parameters are represented once even though the parameters are needed for all the data slices. As the table shows, Data Slice Definitions can be reused for different purposes as long as the Data Slice Definitions are properly parametrized. The same source, e.g., GL Balances, is used for multiple purposes. Only a subset of data from each data source is typically needed, however, different subsets are needed for different use cases. Additionally, the same subset of data can be used for multiple purposes. Therefore, it makes sense to allow the definition of a reusable data slice. This will allow consumers to define a data slice once and use it in multiple places consistently. In addition, to avoid the proliferation of data slice definitions, there should be parameterized so that a single data slice definition can serve multiple use cases.

### 7. Computer Networks and Cloud Networks

In some embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In some embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In some embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In some embodiments, a service provider provides a cloud network to one or more end users. Various service models may be implemented by the cloud network, including but not limited to Software-as-a-Service (Saas), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In some embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGA s), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICS, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

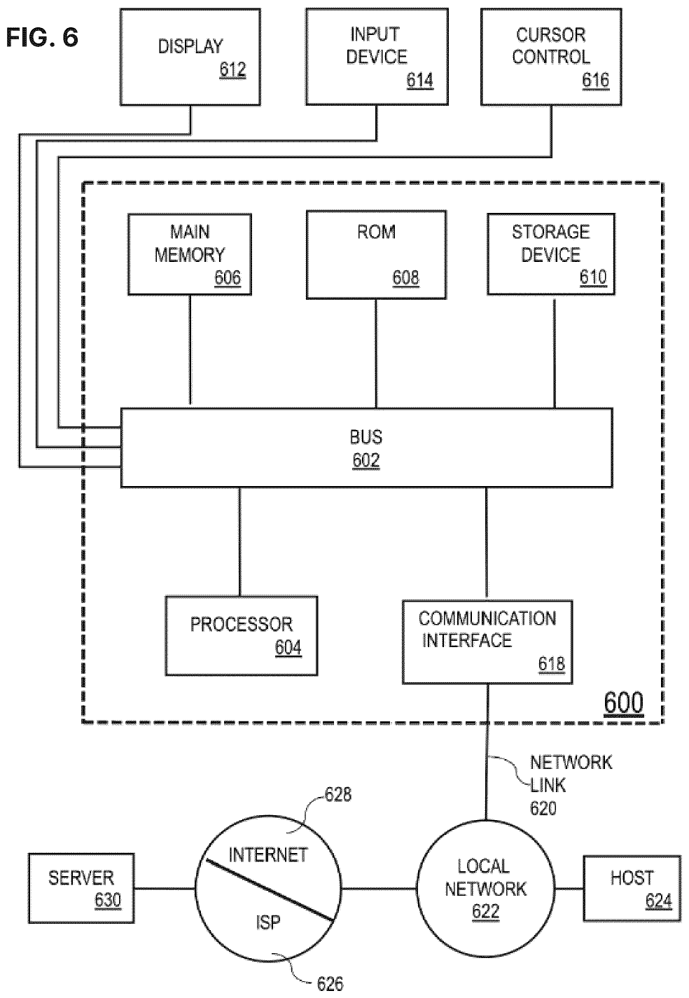

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 9. Miscellaneous; Extensions

Embodiments are directed to a system with one or more devices that include a hardware processor and that are configured to perform any of the operations described herein and/or recited in any of the claims below.

In some embodiments, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
receiving a request for a dataset associated with a data slice, wherein the request comprises a data slice name and a set of parameters associated with the data slice;
accessing metadata for an object or view associated with the data slice to determine operations for accessing the dataset associated with the request, wherein the dataset associated with the request is a subset of data associated with the object or view;
generating a database query for retrieving the dataset associated with the request;
executing the database query on a database to retrieve the data associated with the request; and
returning the dataset associated with the request.

2. The one or more non-transitory computer-readable media of claim 1, wherein the set of parameters associated with the data slice comprises one or more filter conditions, qualifiers, aggregation method, or grouping criteria.

3. The one or more non-transitory computer-readable media of claim 1, wherein the operations for accessing data associated with the request comprise one or more join conditions.

4. The one or more non-transitory computer-readable media of claim 1, wherein the database is a read-only data store; and
wherein the operations further comprise:
performing, on an ongoing basis, a physical-layer replication of a read-write database to the read-only data store.

5. The one or more non-transitory computer-readable media of claim 1, wherein the operations further comprise;
validating the request to confirm required parameters are present and parameter values are valid.

6. The one or more non-transitory computer-readable media of claim 1, wherein the metadata comprises business objects, business views, or analytic views.

7. The one or more non-transitory computer-readable media of claim 1, wherein dataset associated with the data slice is a subset of a dataset associated with a data slice collection.

8. The one or more non-transitory computer-readable media of claim 1, wherein the data slice is user configured.

9. A method comprising:
receiving a request for a dataset associated with a dataslice, wherein the request comprises a data slice name and a set of parameters associated with the data slice;
accessing metadata for an object or view associated with the data slice to determine operations for accessing the dataset associated with the request, wherein the dataset associated with the request is a subset of data associated with the object or view;
generating a database query for retrieving the dataset associated with the request;
executing the database query on a database to retrieve the data associated with the request; and
returning the dataset associated with the request;
wherein the method is performed by at least one device including a hardware processor.

10. The method of claim 9, wherein the set of parameters associated with the data slice comprises one or more filter conditions, qualifiers, aggregation method, or grouping criteria.

11. The method of claim 9, wherein the operations for accessing data associated with the request comprise one or more join conditions.

12. The method of claim 9, wherein the database is a read-only data store, and further comprising:
performing, on an ongoing basis, a physical-layer replication of a read-write database to the read-only data store.

13. The method of claim 9, further comprising:
validating the request to confirm required parameters are present and parameter values are valid.

14. The method of claim 9, wherein the metadata comprises business objects, business views, or analytic views.

15. The method of claim 9, wherein dataset associated with the data slice is a subset of a dataset associated with a data slice collection.

16. The method of claim 9, wherein the data slice is user configured.

17. A system comprising:
at least one device including a hardware processor;
the system being configured to perform operations comprising:
receiving a request for a dataset associated with a data slice, wherein the request comprises a data slice name and a set of parameters associated with the data slice;
accessing metadata for an object or view associated with the data slice to determine operations for accessing the dataset associated with the request, wherein the dataset associated with the request is a subset of data associated with the object or view;
generating a database query for retrieving the dataset associated with the request;
executing the database query on a database to retrieve the data associated with the request; and
returning the dataset associated with the request.

18. The system of claim 17, wherein the set of parameters associated with the data slice comprises one or more filter conditions, qualifiers, aggregation method, or grouping criteria.

19. The system of claim 17, wherein the operations for accessing data associated with the request comprise one or more join conditions.

20. The system of claim 17, wherein the database is a read-only data store; and
wherein the operations further comprise:
performing, on an ongoing basis, a physical-layer replication of a read-write database to the read-only data store.
